(19) United States
(12) Patent Application Publication
(10) Pub. No.: US 2009/0242536 A1
(43) Pub. Date: Oct. 1, 2009

(54) METAL-BASED FLUX CORD WIRE FOR AR-CO2 MIXED GAS SHIELDED ARC WELDING

(75) Inventors: Shushiro NAGASHIMA, Tokyo (JP); Masao KAMADA, Tokyo (JP); Yuki KAYAMORI, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NIPPON STEEL & SUMIKIN WELDING CO., LTD., Tokyo (JP)

(21) Appl. No.: 12/405,357

(22) Filed: Mar. 17, 2009

(30) Foreign Application Priority Data
Mar. 26, 2008 (JP) 2008-080589
Jan. 16, 2009 (JP) 2009-007865

(51) Int. Cl. B23K 35/02

(52) U.S. Cl. 219/145.22

(57) ABSTRACT

A metal-based flux cored wire for Ar—CO₂ mixed gas shielded arc welding used for short arc welding and spray arc welding. The wire results in extremely small amounts of slag formation and spatter generation, giving a good bead shape, and giving excellent low-temperature toughness of the weld metal. The flux cored wire includes a steel sheath in which a flux is filled, and the flux contains a metal powder in 97 mass % or more, and the wire contains, by mass % with respect to the total weight of the wire, C: 0.03 to 0.12%, Si: 0.5 to 1.2%, Mn: to 3.5%, S: 0.005 to 0.05%, iron powder with amount of oxygen of 0.25% or less: 4.0 to 15.5%, a total of one or more of alkali metal oxides, alkali metal fluorides, and metal oxides: 0.35% or less, and the balance of mainly Fe ingredient of the steel sheath and Fe ingredients from the flux etc. and unavoidable impurities.

### CROSS-REFERENCE TO RELATED APPLICATION

This application is based upon and claims the benefit of priority of the prior Japanese Patent Application No. 2009-007865, filed on Jan. 16, 2009,and the prior Japanese Patent Application No. 2008-080589, filed on Mar. 26, 2008 the entire contents of which are incorporated herein by reference.

### BACKGROUND OF THE INVENTION

1. Field of the Invention

The present invention relates to a metal-based flux cored wire for Ar—CO₂ mixed gas shielded arc welding, more particularly, it relates to a metal-based flux cored wire for Ar—CO₂ mixed gas shielded arc welding (hereinafter referred to as “metal-based flux cored wire for Ar—CO₂ welding”) capable of being used for both short arc welding and spray arc welding, resulting in an extremely small amount of slag formation and small amount of spatter generation, giving a good bead shape, and furthermore giving an excellent low-temperature toughness of the weld metal.

2. Description of the Related Art

In the fields of construction machinery, steel frames, etc., fillet welding and joint welding are often continuously welded by multiple passes. Flux cored wires resulting in a large amount of slag formation such as rutile-based slag and basic-based slag are not preferred. Solid wire with a small amount of slag formation and metal-based flux cored wire with high welding ability and high efficiency are being preferred. Metal-based flux cored wire facilitates the slag removal in continuous multipass welding and enables short arc welding (short circuit transition) in the low welding current region, so that it is suitable for a welding of thin-gauge plate or a formation of penetration bead by initial layer pass in one side joint welding where burn-through often occurs in spray arc welding.

Further advantages of metal-based flux cored wire for Ar—CO₂ welding, compared with metal-based flux cored wire for CO₂ gas shielded arc welding, are the smaller size of the molten droplets, i.e., the prevention of formation of large droplets of spatter, the smooth bead shape, and the small degree of slag formation due to oxidation of Mn, Si, other alloy agents and deoxidizing agents decreasing total amount of slag formation. Furthermore, the smaller amount of slag is also effective for reducing the amount of oxygen in the weld metal and improving the impact toughness.

In conventional metal-based flux cored wire, there have been many proposals for improving the welding efficiency mainly for CO₂ gas shielded arc welding. For example, Japanese Patent Publication (A) No. 2-274395 describes a metal-based flux cored wire containing 54 to 85% of iron powder in the flux to improve the weldability in the low current region. However, because carboxymethyl cellulose is included in the flux, when the metal-based flux cored wire is applied to Ar—CO₂ mixed gas shielded arc welding, the arc in the spray arc welding was rough (unstable) and spatter generation increases. Japanese Patent Publication (A) No. 63-215395 describes a metal-based flux cored wire having at least 90% of metal powder in the flux to improve the weldability in the low welding current region. However, the flux cored wire contains significant amounts of metal oxides such as SiO₂, Al₂O₃, MgO, and strong deoxidizing ingredients such as Ti, Al, Mg. When the flux cored wire is applied to Ar—CO₂ mixed gas shielded arc welding, the arc becomes rough, and both spatter generation and slag formation increase. Further, Japanese Patent Publication (A) No. 6-226492 describes a metal-based flux cored wire having at least 94% of metal powder in the flux to reduce generation of fumes. However, Ti or Ti oxides are included in the flux cored wire, so that when Ar—CO₂ mixed gas shielded arc welding is performed, the bead surface is covered by a thin slag layer and it becomes difficult to remove the slag.

On the other hand, Japanese Patent Publication (A) No. 2000-197991 proposes a metal-based flux cored wire for Ar—CO₂ welding in which the amount of slag formation is small and the bead shape is improved. However, because the content of the metal powder is small, there are problems that spatter is generated in short arc welding in large quantity and sufficient low-temperature toughness of the weld metal is not obtained.

### SUMMARY OF THE INVENTION

An object of the present invention is to provide a metal-based flux cored wire for Ar—CO₂ mixed gas shielded arc welding with extremely small amount of slag formation and spatter generation when used for short arc welding and spray arc welding, giving a good bead shape, and giving an excellent low-temperature toughness of the weld metal.

An aspect of the present invention is to provide a metal-based flux cored wire for Ar—CO₂ mixed gas shielded arc welding having a steel sheath filled with flux, in which the flux contains a metal powder in 97 mass % or more, and the metal-based flux cored wire comprises of, by mass % with respect to the total weight of the wire, C: 0.03 to 0.12%, Si: 0.5 to 1.2%, Mn: 1.5 to 3.5%, S: 0.005 to 0.05%, an iron powder with amount of oxygen of 0.25% or less: 4.0 to 15.5%, a total of one or more of alkali metal oxides, alkali metal fluorides, and metal oxides:0.35% or less, and the balance of mainly Fe ingredient of the steel sheath and Fe ingredients from the flux(ferroalloy) etc. and unavoidable impurities.

Preferably the total of Na converted value and K converted value of the alkali metal oxides and alkali metal fluorides is 0.10% or less and F converted value of the alkali metal fluorides is 0.10% or less.

Another aspect of the present invention is a metal-based flux cored wire for Ar—CO₂ mixed gas shielded arc welding containing one or both of Ni: 0.3 to 1.5% and B: 0.003 to 0.010%.

According to the metal-based flux cored wire for Ar—CO₂ mixed gas shielded arc welding of the present invention, the work for removal of the slag or spatter can be greatly reduced when used for fillet welding or joint multipass welding in the fields of construction machinery or iron frames. Also, the bead shape is good, and the low-temperature toughness of the weld metal is excellent. Thus, it become possible to obtain a high quality weldments efficiently.

### DESCRIPTION OF THE PREFERRED EMBODIMENTS

The present inventors studied various flux cored wires to solve the above problems investigated the effects of the various compositions of ingredients on the arc conditions, such as amount of spatter generation, amount of slag formation, bead shape, slag removal, and mechanical properties of the weld metal in spray arc welding and short arc welding for Ar—CO₂ mixed gas shielded arc welding.

As a result, they discovered that ultralow amount of slag formation is achieved by lowering the total amount of the alkali metal oxides, alkali metal fluorides, and metal oxides, which cause slag formation to increase. they also found stable low-temperature toughness is obtained by limiting oxygen of the iron powder to a low amount, a low amount of oxygen in the weld metal. They further discovered that by limiting the amounts of Na, K, and F, excellent arc conditions in both the spray arc welding and the short arc welding can be achieved and the amount of spatter generation can be remarkably reduced.

Furthermore, they discovered that by including at least one of Ni and B, an excellent toughness of the weld metal at a low temperature is also obtained.

Reasons for the limitation of the ingredients of the flux cored wire of the present invention will be explained below.

(Metal Powder in Flux: 97 Mass % or More)

In order to improve the properties which enable both high weldability and continuous multipass welding with ultralow slag of a metal-based flux wire, the slag forming agents were kept to a minimum amount and the metal powder in the flux was made 97 mass % (hereinafter referred to as “%”) or more. If the metal powder in the flux is less than 97%, i.e., the amount of the slag forming agents relatively increases, the amount of slag formation and time to remove the slag increase in multipass welding, thus, the welding efficiency falls. Further, if the flux contains too much slag forming agents, in particular in short arc welding, the arc becomes unstable and spatter generation increases. It should be noted that the metal powder in the flux is mainly comprised of ferroalloy powder and/or iron powder which may contain C, Si, Mn, and other alloy ingredients such as Ni, B therein.

(C: 0.03 to 0.12%)

C is added not only in the form of graphite, but also in the form of carbon ingredient contained in the steel sheath, ferromanganese, ferrosilicon manganese, and iron powder. It is an important ingredient for securing strength and toughness of the weld metal. Further, it has the effects of strengthening the arc concentrating ability and arc strength. In particular, in the metal-based flux cored wire for Ar—CO₂ welding, the amount of C has a large effect on the arc conditions. To obtain a stable arc conditions, it is important that the amount of C be in the prescribed range. If C is less than 0.03%, the strength and toughness of weld metal decrease, and the arc concentrating ability and arc strength decreases. At the low welding current side in spray arc welding, many large droplets of spatter are generated and adhere on the base material. On the other hand, if over 0.12%, the weld metal becomes too high in strength but the toughness falls. Further, the arc strength becomes too strong and spatter generation increases.

(Si: 0.5 to 1.2%)

Si is added in the forms of steel sheath, metal silicon, ferrosilicon, ferrosilicon manganese, etc. It is an important ingredient for securing strength and toughness of the weld metal. It also plays a role in raising the viscosity of the molten metal and achieving uniform bead shape. If Si is less than 0.5%, the strength and toughness decrease. Further, viscosity of the molten metal becomes insufficient and the fillet welded bead shape becomes too convex. On the other hand, if Si is over 1.2%, the weld metal becomes too high in strength and the toughness falls.

(Mn: 1.5 to 3.5%)

Mn is added in the forms of steel sheath, metal manganese, ferromanganese, ferrosilicon manganese, etc. It is an important ingredient for securing strength and toughness of the weld metal. If Mn is less than 1.5%, the strength and toughness of weld metal decrease. On the other hand, if Mn is over 3.5%, the weld metal becomes too high in strength but the toughness falls.

(S: 0.005 to 0.05%)

S is added in the forms of steel sheath ingredients and iron sulfide etc. and is used as a slag aggregation agent and slag removal agent. Because metal-based flux cored wire for Ar—CO₂ welding of the present invention is extremely small in amount of slag formation, in order to efficiently remove the slag, it is necessary to make the slag aggregate into a mass to facilitate slag removal. If S is less than 0.005%, the slag is scattered in small amounts slightly on the bead surface and the slag removal becomes difficult. Further, if S is over 0.05%, hot cracks easily occur in the weld metal.

(Iron Powder with Amount of Oxygen of Iron Powder of 0.25% or Less: 4.0 to 15.5%)

Iron powder is an essential ingredient for securing the property of ultralow slag formation and the high welding ability of the metal-based flux cored wire. If the iron powder is less than 4.0%, the high welding ability falls and the advantages of the metal-based flux cored wire will not be sufficiently exhibited. On the other hand, if the iron powder is over 15.5%, the flux filling rate will fluctuate in the longitudinal direction of the wire in the drawing process at the stage of wire production, also, the arc conditions will become unstable, and spatter generation will increase.

In the metal-based flux cored wire for Ar—CO₂ mixed gas shielded welding of the present invention, in order to reduce the amount of oxygen in the weld metal and secure sufficient low-temperature impact toughness, iron powder with a low amount of oxygen is used. If the amount of oxygen of the iron powder is over 0.25%, the amount of oxygen in the weld metal becomes too high and the impact toughness of the weld metal decreases. By using hydrogen-reduced iron powder, atomized iron powder, etc. with an amount of oxygen of the iron powder of 0.25% or less, it becomes possible to lower the amount of oxygen in the weld metal to 0.05% or less and obtain sufficient low-temperature toughness without adding deoxidizing agent such as Ti, Al, Mg, Zr which causes an increase of the amount of slag formation.

(Total of One or More of Alkali Metal Oxides, Alkali Metal Fluorides, and Metal Oxides: 0.35% or Less)

If the total of alkali metal oxides formed by potassium titanate, potassium silicate, sodium silicate, etc., alkali metal fluorides formed by sodium fluoride, potassium silicofluoride, cryolite, and lithium fluoride, and metal oxides formed by TiO₂, SiO₂, Al₂O₃, MgO, ZrO₂, etc. is over 0.35%, the amount of slag formation is increased, the work of slag removal takes significant time in multi-pass welding, and the welding efficiency falls. Further, in particular, in short arc welding, the arc becomes unstable and spatter generation increases. Furthermore, when the amount of oxygen in the weld metal is increased, the toughness falls. Therefore, the total of one or more of alkali metal oxides, alkali metal fluorides, and metal oxides is in amount of 0.35% or less.

(Total of Na Converted Value and K Converted Value of Alkali Metal Oxides and Alkali Metal Fluorides: 0.10% or Less)

Alkali metal oxides and alkali metal fluorides also act as arc stabilizers, and these may be added in an amount of 0.10% or less by total of Na converted value and K converted value. If the total of the Na converted value and K converted value is over 0.10%, slag with poor removability will adhere on the bead surface.

(F Converted Value of Alkali Metal Fluorides: 0.10% or Less)

Alkali metal fluorides raise the concentrating ability of the arc in spray arc welding and improve the arc conditions. These decrease occurrence of undercut caused by arc instability, and these can be added 0.10% or less by F converted value of alkali metal fluorides. If the F converted value is over 0.10%, the arc becomes too strong and spatter generation increases.

(One or More of Ni: 0.3 to 1.5% and B: 0.003 to 0.010%)

Ni and B also improve the toughness of the weld metal at a low temperature. If Ni is less than 0.30% and B is less than 0.003%, little improvement in the toughness of the weld metal will be expected. On the other hand, if Ni is more than 1.5% or B is over 0.010%, hot cracks are liable to occur.

It should be noted that by greatly reducing metal oxides such as TiO₂, SiO₂, Al₂O₃, MgO, ZrO₂, the arc condition is stabilized and spatter generation decreases. Further, because these oxides increase the amount of oxygen in the weld metal and decreases the low-temperature toughness, the total of the metal oxides should be kept to 0.15% or less. Furthermore, it is not preferable to add strong deoxidizing agents such as Ti, Al, Mg, and Zr, to reduce oxygen in the weld metal because these will form metal oxides which increase the amount of slag formation.

Also, if the flux filling rate (ratio of mass of flux filled with respect to total mass of wire) is low, spatter generation will increase in short arc welding and spray arc welding and the bead shape will become too convex with poor adherence with the base material. On the other hand, if the flux filling rate is high, the arc will spread too much at the high welding current side of spray arc welding, undercut increases at the base material. Also, the arc strength will be weakened, and the depth of penetration will become small and insufficient melting of the base metal will increase in fillet welding. Therefore, the flux filling rate is preferably 8 to 20%.

The shield gas at the time of welding is made an Ar-5 to 25% CO₂ mixed gas to reduce the amount of slag formation and amount of oxygen in the weld metal.

The metal-based flux cored wire for Ar—CO₂ welding of the present invention is produced by filling flux in a mild steel or alloy steel sheath having good drawability after being filled with flux, then using die drawing or roller drawing to reduce the wire to a predetermined diameter (1.0 to 1.6 mm). The cross-sectional structure of the wire may be the same as that of commercially available flux wires and is not particularly limited.

Below, examples will be used to explain the effects of the present invention in further detail.

### EXAMPLE 1

First, using JIS G3141 SPCC steel strip, the flux cored wires of wire diameters of 1.2 mm and the various ingredients shown in Table 1 were prepared. The flux filling rate was 8.5 to 19%.

Using each of the flux cored wires shown in Table 1, 12 mm thick steel plates (JIS G3106 SM490A) arranged in T-shaped fillet test pieces (lengths 500 mm) were horizontally fillet welded under the welding conditions shown in Table 2. The arc conditions were investigated by spray arc welding (Condition No. 1) and by short arc welding (Condition No. 2). Also, the amount of spatter generation, bead shape, and amount of slag formation in spray arc welding (Condition No. 1) were investigated. The amount of spatter generation was measured by collecting the total amount of the spatter, converting it to the mass generated per minute of welding time. The spatter generation of 0.5 g/min or less is defined as “good”. The amount of slag formation was converted to the amount formed per meter of bead length. The slag formation of 6 g/m or less was defined as “good”.

TABLE 1

| | | | Wire ingredients (mass % with respect to total mass of wire) | | | | | | | | |
|---|---|---|---|---|---|---|---|---|---|---|---|
| | | Am't of | | | | | | | *1 | *2 | |
| | | metal | | | | | Iron powder | | Total of | Total of Na | |
| | | powder in | | | | | Am't of | | slag | and K | *3 |
| | | flux | | | | | oxygen | | forming | converted | F converted |
| Class | Wire no. | (mass %) | C | Si | Mn | S | (mass %) | Content | agents | values | value |
| Inv. ex. | 1 | 98.6 | 0.04 | 0.83 | 2.91 | 0.014 | 0.198 | 10.6 | 0.21 | 0.02 | 0.04 |
| | 2 | 97.1 | 0.08 | 0.61 | 2.78 | 0.025 | 0.203 | 4.5 | 0.26 | 0.05 | — |
| | 3 | 99.1 | 0.05 | 0.85 | 3.19 | 0.019 | 0.113 | 8.9 | 0.14 | 0.06 | 0.02 |
| | 4 | 99.5 | 0.06 | 0.63 | 2.48 | 0.033 | 0.137 | 5.4 | 0.05 | — | — |
| | 5 | 99.2 | 0.03 | 1.06 | 2.15 | 0.009 | 0.243 | 5.4 | 0.08 | — | 0.02 |
| | 6 | 99.1 | 0.11 | 1.14 | 1.81 | 0.039 | 0.245 | 8.9 | 0.12 | 0.03 | 0.02 |
| | 7 | 99.3 | 0.09 | 0.62 | 2.19 | 0.024 | 0.164 | 4.9 | 0.06 | — | — |
| | 8 | 99.3 | 0.05 | 0.92 | 2.29 | 0.041 | 0.139 | 15.2 | 0.13 | 0.03 | 0.02 |
| | 9 | 98.5 | 0.12 | 0.82 | 1.97 | 0.035 | 0.113 | 7.6 | 0.18 | 0.05 | — |
| | 10 | 98.2 | 0.03 | 0.87 | 2.67 | 0.017 | 0.188 | 11.4 | 0.31 | 0.09 | 0.08 |
| Comp. ex. | 11 | 96.0 | 0.06 | 0.89 | 1.83 | 0.019 | 0.213 | 9.2 | 0.56 | 0.08 | 0.07 |
| | 12 | 98.1 | 0.02 | 1.02 | 2.00 | 0.008 | 0.186 | 3.3 | 0.16 | 0.07 | 0.02 |
| | 13 | 99.2 | 0.13 | 0.63 | 2.41 | 0.003 | 0.221 | 13.0 | 0.14 | 0.03 | 0.05 |
| | 14 | 98.0 | 0.04 | 0.45 | 1.94 | 0.022 | 0.181 | 11.5 | 0.31 | 0.08 | 0.15 |
| | 15 | 98.0 | 0.10 | 1.31 | 2.02 | 0.034 | 0.201 | 9.6 | 0.29 | 0.14 | 0.02 |
| | 16 | 98.6 | 0.05 | 0.74 | 1.34 | 0.022 | 0.194 | 16.2 | 0.26 | 0.08 | 0.04 |
| | 17 | 98.5 | 0.08 | 0.98 | 3.68 | 0.054 | 0.143 | 5.1 | 0.17 | — | — |
| | 18 | 98.6 | 0.08 | 0.70 | 1.60 | 0.034 | 0.321 | 7.9 | 0.15 | — | — |
| | 19 | 97.8 | 0.05 | 0.68 | 1.87 | 0.024 | 0.157 | 13.8 | 0.40 | 0.09 | 0.06 |

*1: Slag forming agents are one or more of alkali metal oxides, alkali metal fluorides, and metal oxides (potassium titanate, potassium silicate, sodium silicate, potassium silicofluoride, cryolite, sodium fluoride, lithium fluoride, TiO₂, SiO₂, Al₂O₃, MgO, ZrO₂, etc.)
*2: Total of Na converted value and K converted value of alkali metal oxides and alkali metal fluorides.
*3: F converted value of alkali metal fluorides.
Balance of Fe of steel sheath and Fe ingredient from the flux (ferroalloy) etc. and unavoidable impurities.

TABLE 2

| | Welding | Arc | Welding | Shield gas |
|---|---|---|---|---|
| Condition no. | current | voltage | speed | flow rate |
| 1 | 270 A | 29 V | 30 cm/min | 80% Ar—20% CO₂ |
| 2 | 120 A | 15 V | 60 cm/min | 25 liters/min |

Condition No. 1 is spray arc welding
Condition No. 2 is short arc welding

Next, in accordance with JIS Z3313, a 20 mm thick steel plate (JIS G3126 SLA235A) was used for a welded metal test under the welding condition No. 1 shown in Table 2 to obtain tensile test pieces and impact toughness test pieces. Here, tensile strengths of 520 to 640 N/mm² and absorption energies at the test temperature of −40° C. of an average for three pieces of 60 J or more were defined as “good”. These results are shown together in Table 3.

TABLE 3

| | | Spray arc welding | | | | | | | | | | |
|---|---|---|---|---|---|---|---|---|---|---|---|---|
| | | | | Am't | | | | | | | | |
| | | | | of | | Am't of | | | | | | |
| | | | | formation | | occurrence | | | | Mechanical properties | | |
| | | | | of | | of | | Short arc welding | | Tensile | Absorption | |
| | Wire | Arc | Bead shape/ | slag | Slag | spatter | | Arc | | strength | energy | Overall |
| Class | no. | conditions | appearance | (g/m) | removal | (g/min) | Hot cracks | conditions | Remarks | (N/mm²) | −40° C. (J) | evaluation |
| Inv. | 1 | Good | Good | 4.2 | Good | 0.24 | None | Good | — | 552 | 74 | Good |
| ex. | 2 | Good | Good | 3.9 | Good | 0.28 | None | Good | — | 615 | 73 | Good |
| | 3 | Good | Good | 3.1 | Good | 0.21 | None | Good | — | 604 | 97 | Good |
| | 4 | Good | Good | 2.8 | Good | 0.22 | None | Good | — | 597 | 88 | Good |
| | 5 | Good | Good | 2.9 | Good | 0.24 | None | Good | — | 536 | 75 | Good |
| | 6 | Good | Good | 3.2 | Good | 0.31 | None | Good | — | 601 | 71 | Good |
| | 7 | Good | Good | 2.4 | Good | 0.19 | None | Good | — | 584 | 79 | Good |
| | 8 | Good | Good | 4.2 | Good | 0.27 | None | Good | — | 576 | 82 | Good |
| | 9 | Good | Good | 3.7 | Good | 0.25 | None | Good | — | 599 | 97 | Good |
| | 10 | Good | Good | 4.9 | Good | 0.27 | None | Good | — | 528 | 76 | Good |
| Comp. | 11 | Good | Welded am't | 7.4 | Poor | 0.48 | None | Unstable | Spatter | 526 | 32 | Poor |
| ex. | | | small | | | | | | large | | | |
| | 12 | Arc weak | Welded am't | 5.4 | Good | 0.65 | None | Arc weak | — | 512 | 31 | Poor |
| | | | small | | | | | | | | | |
| | 13 | Arc too | Good | 5.1 | Poor | 0.68 | None | Arc too | Spatter | 658 | 47 | Poor |
| | | strong | | | | | | strong | somewhat | | | |
| | | | | | | | | | large | | | |
| | 14 | Arc too | Protruding | 4.9 | Good | 0.67 | None | Arc too | Spatter | 511 | 24 | Poor |
| | | strong | bead | | | | | strong | somewhat | | | |
| | | | | | | | | | large | | | |
| | 15 | Good | Good | 4.2 | Poor | 0.31 | None | Good | — | 655 | 41 | Poor |
| | 16 | Unstable | Good | 3.9 | Good | 0.64 | None | Unstable | Spatter | 516 | 27 | Poor |
| | | | | | | | | | large | | | |
| | 17 | Good | Good | 3.4 | Good | 0.29 | Yes | Good | — | 648 | 45 | Poor |
| | | | | | | | (crater | | | | | |
| | | | | | | | crack) | | | | | |
| | 18 | Good | Good | 2.7 | Good | 0.25 | None | Good | — | 581 | 27 | Poor |
| | 19 | Good | Good | 7.8 | Poor | 0.53 | None | Unstable | Spatter | 564 | 27 | Poor |
| | | | | | | | | | large | | | |

Wire Nos. 1 to 10 in Table 1 and Table 2 are embodiments of the present invention (invention examples), while Wire Nos. 11 to 19 are comparative examples. The invention examples of Wire Nos. 1 to 10 were of preferable amount of metal powder in the flux, the C, Si, Mn, S, iron powder and also of preferable amount of oxygen of the iron powder, and total of the alkali metal oxides, alkali metal fluorides, and metal oxides of the fluxes. These examples were excellent in all of the arc conditions, amount of spatter generation, bead shape, amount of slag formation, and slag removal in both spray arc welding and short arc welding. Furthermore, these examples were excellent in the mechanical properties in the welded metal test, with no hot cracks in the weld metal. These were excellent results.

Wire No. 11 among the comparative examples was low in metal powder in the flux, i.e., it was relatively high in the total of the alkali metal oxides, alkali metal fluorides, and metal oxides (slag forming agents). The wire formed a large amount of slag requiring time for slag removal, and the welded amount was also small. Further, in short arc welding, the arc was unstable and the amount of spatter generation was large. Furthermore, the amount of oxygen in the weld metal was high and the absorption energy value was low.

Wire No. 12 had a low C, and it was weak in arc strength. Therefore, the arc was unstable in spray arc welding and many large droplets of spatter were generated. Further, because the amount of iron powder was low, the welded amount was also small.

Wire No. 13 had a high C, and the weld metal had high tensile strength but poor in absorption energy value. Further, the arc was too strong and much spatter was generated. Furthermore, because it had low S, slag was scattered in small droplets on the bead and it was difficult to remove the slag.

Wire No. 14 had a low Si, and the weld metal had a too convex bead. Also, the tensile strength was low and the absorption energy value was also low. Furthermore, because the F converted value of the alkali metal fluorides was high, the arc became too strong and a large amount of spatter was generated.

Wire No. 15 had a high Si, and the tensile strength of the weld metal was high and the absorption energy value was low. Further, because the total of the Na converted value and K converted value of the alkali metal oxides and alkali metal fluorides were also high, it was difficult to remove the slag.

Wire No. 16 had a low Mn, and the weld metal had a low tensile strength and a low absorption energy value. Further, because it was high in iron powder, the arc was unstable and a large amount of spatter was generated.

Wire No. 17 had a high Mn, and the tensile strength of the weld metal was high but the absorption energy value was low. Further, because it had a high S, crater cracks occurred.

Wire No. 18 had a high amount of oxygen of the iron powder, and the absorption energy value of the weld metal was low.

Wire No. 19 had a high total amount of alkali metal oxides, alkali metal fluorides, and metal oxides, and a large amount of slag was formed requiring significant time to remove the slag. Further, in short arc welding, the arc was unstable and a large amount of spatter was generated. Furthermore, the amount of oxygen in the weld metal was high and the absorption energy value was also low.

### EXAMPLE 2

Using JIS G3141 SPCC steel strip for the steel sheath, flux cord wires of wire diameters of 1.2 mm and the various ingredients shown in Table 4 were prepared. Using the flux cored wires shown in Table 4, in accordance with JIS Z3313, a 20 mm thick steel plate (JIS G3126 SLA235A) was used for a welded metal test under the welding condition No. 1 shown in Table 2 to obtain tensile test pieces and impact test pieces for testing. Here, tensile strengths of 520 to 640 N/nm² and absorption energies at a test temperature of −60° C. of an average for three pieces of 60J or more were defined as “good”. These results are also shown together in Table 4.

TABLE 4

| | | | Wire ingredients (mass % with respect to total mass of wire) | | | | | | | |
|---|---|---|---|---|---|---|---|---|---|---|
| | | | | | | | | | | *2 |
| | | Am't | | | | | | | *1 | Total |
| | | of metal | | | | | Iron powder | | Total | of Na |
| | | powder | | | | | Am't of | | of slag | and K |
| | Wire | in flux | | | | | oxygen | | forming | converted |
| Class | no. | (mass %) | C | Si | Mn | S | (mass %) | Content | agents | values |
| Inv. | 20 | 99.1 | 0.04 | 0.86 | 2.31 | 0.018 | 0.194 | 9.8 | 0.13 | 0.06 |
| ex. | 21 | 98.4 | 0.08 | 0.79 | 2.49 | 0.021 | 0.172 | 9.2 | 0.22 | 0.06 |
| | 22 | 99.4 | 0.06 | 0.84 | 2.17 | 0.028 | 0.204 | 5.5 | 0.07 | — |
| | 23 | 98.7 | 0.04 | 0.70 | 1.94 | 0.031 | 0.142 | 9.9 | 0.20 | 0.06 |
| | 24 | 98.9 | 0.04 | 0.83 | 2.21 | 0.027 | 0.201 | 7.1 | 0.14 | — |
| | 25 | 99.0 | 0.07 | 0.66 | 1.82 | 0.037 | 0.175 | 8.9 | 0.13 | 0.04 |
| Comp. | 26 | 98.4 | 0.07 | 0.88 | 2.21 | 0.036 | 0.164 | 8.1 | 0.21 | 0.06 |
| ex. | 27 | 98.7 | 0.05 | 1.10 | 2.21 | 0.024 | 0.173 | 6.1 | 0.17 | 0.04 |
| | 28 | 98.6 | 0.05 | 0.77 | 2.21 | 0.026 | 0.205 | 8.5 | 0.18 | — |
| | 29 | 98.5 | 0.05 | 0.83 | 1.92 | 0.031 | 0.198 | 8.1 | 0.20 | 004 |

| | | Wire ingredients (mass % | | | Mechanical properties | | | |
|---|---|---|---|---|---|---|---|---|
| | | with respect to total mass of wire) | | | | Absorption | | |
| | | *3 | | | Tensile | energy | | |
| | Wire | F converted | | | strength | −60° C. | | Overall |
| Class | no. | value | Ni | B | (N/mm²) | (J) | Others | evalution |
| Inv. | 20 | 0.01 | 0.32 | — | 609 | 97 | — | Good |
| ex. | 21 | 0.03 | — | 0.0042 | 587 | 85 | — | Good |
| | 22 | — | 0.68 | 0.0044 | 605 | 108 | — | Good |
| | 23 | 0.03 | 0.86 | 0.0060 | 576 | 117 | — | Good |
| | 24 | 0.03 | 1.43 | — | 615 | 122 | — | Good |
| | 25 | 0.01 | — | 0.0091 | 608 | 109 | — | Good |
| Comp. | 26 | 0.03 | 0.13 | 0.0013 | 593 | 54 | — | Poor |
| ex. | 27 | 0.03 | 1.69 | — | 618 | 97 | Crater | Poor |
| | | | | | | | crack | |
| | 28 | 0.02 | — | 0.0016 | 592 | 36 | — | Poor |
| | 29 | 0.04 | — | 0.0117 | 601 | 75 | Crater | Poor |
| | | | | | | | crack | |

*1: Slag forming agents are one or more of alkali metal oxides, alkali metal fluorides, and metal oxides (potassium titanate, potassium silicate, sodium silicate, potassium silicofluoride, cryolite, sodium fluoride, lithium fluoride, TiO₂, SiO₂, Al₂O₃, MgO, ZrO₂, etc.)
*2: Total of Na converted value and K converted value of alkali metal oxides and alkali metal fluorides.
*3: F converted value of alkali metal fluorides.
Balance of Fe of steel sheath and Fe ingredients from the flux (ferroalloy) etc., and unavoidable impurities.

Wire Nos. 20 to 25 in Table 4 are embodiments of the present invention (invention examples), while Wire Nos. 26 to 29 are comparative examples. The invention examples of Wire Nos. 20 to 25 contained suitable amounts of at least one of Ni or B of the wires, the weld metal were significantly superior to those of comparative examples in mechanical properties in the weld metal tests. Further, because they had preferred amount of metal powder in the flux, C, Si, Mn, S, iron powder and amount of oxygen of the iron powder, and total of alkali metal oxides, alkali metal fluorides, and metal oxides of the fluxes, they were excellent in all of the arc conditions in spray arc welding and short arc welding in the separate fillet weld tests, amount of spatter generation, bead shape, amount of slag formation, and slag removal.

The comparative example Wire No. 26 had low Ni and B, while the Wire No. 28 had low B, and the weld metal of Wire Nos. 26 and 28 showed low absorption energy values.

Wire No. 27 had high Ni, while Wire No. 29 had high B, and the weld metal of these suffered crater cracks.

While the invention has been described with reference to specific embodiments chosen for purpose of illustration, it would be apparent that numerous modifications could be made thereto by those skilled in the art without departing from the basic concept and scope of the invention.

1. A metal-based flux cored wire for Ar—CO₂ mixed gas shielded arc welding comprising:
a steel sheath, and
a flux filled in the steel sheath, the flux containing metal powder in 97 mass % or more, and
wherein the metal-based flux cored wire comprises, by mass % with respect to the total weight of the wire,
C: 0.03 to 0.12%,
Si: 0.5 to 1.2%,
Mn: 1.5 to 3.5%,
S: 0.005 to 0.05%, and
iron powder with amount of oxygen of 0.25% or less: 4.0 to 15.5%,
total of one or more of alkali metal oxides, alkali metal fluorides, and metal oxides: 0.35% or less, and
the balance of mainly Fe ingredient of the steel sheath, Fe ingredients from the flux etc. and unavoidable impurities.

2. The metal-based flux cored wire for Ar—CO₂ mixed gas shielded arc welding as set forth in claim 1, wherein a total of Na converted value and K converted value of the alkali metal oxides and alkali metal fluorides is 0.10% or less and F converted value of the alkali metal fluoride is 0.10% or less.

3. The metal-based flux cored wire for Ar—CO₂ mixed gas shielded arc welding as set forth in claim 1,characterized by containing furthermore one or both of Ni: 0.3 to 1.5% and B: 0.003 to 0.010%.

4. The metal-based flux cored wire for Ar—CO₂ mixed gas shielded arc welding as set forth in claim 2,characterized by containing furthermore one or both of Ni: 0.3 to 1.5% and B: 0.003 to 0.010%.
